(19) United States
(12) Patent Application Publication
(10) Pub. No.: US 2008/0264911 A1
(43) Pub. Date: Oct. 30, 2008

(54) Non-contact laser carving process and the equipment

(75) Inventors: Tsung-Chien Huang, Taipei (TW); Chiu-Hung Tien, Taipei (TW); Hsun-Min Lee, Taipei (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORPORATION

(21) Appl. No.: 11/797,058

(22) Filed: Apr. 30, 2007

(51) Int. Cl. B23K 26/00

(52) U.S. Cl. 219/121.69; 219/121.68

(57) ABSTRACT

A non-contact laser carving process and the equipment. By the orientation of an orienting module, the center of a wafer can be amended and oriented to the orienting module precisely. By the rotation of the orienting module and an optical sensor of a transmission mechanical module, the center of the wafer can be obtained precisely. By the compensation of the optical sensor, a specific boundary position is oriented. No matter what the external diameter of the wafer is, the specific boundary position in the wafer can be carved by laser precisely through the transmission mechanical module cooperated with a laser-carving unit, and a specific number can be carved at the specific boundary position of each wafer. Therefore, the wafer can be efficiently traced and controlled, and the amount of the wafer can be figured out easily to raise the quality of the wafer.

### BACKGROUND OF THE INVENTION

1. Field of the invention

The present invention relates to a non-contact laser carving process and the equipment, more particularly, to a non-contact laser carving process and the equipment, which makes use of an orienting module cooperated with a transmission mechanical module to accomplish edge detection and detection compensation so as to obtain a predetermined position on a wafer and allow a laser carving unit to carve a specific number at the predetermined position.

2. Description of Related Art

In modernized society that changes with each passing day, various high-tech products used in information and communications have become more and more complicated, and various electronic and mechanical components used in these high-tech products have become the driving power for diversified functions of these high-tech products. Among most electronic or automated products, control chips are used as the most important core components for the control and processing of electronic signals. Because these chips are fabricated with wafer, the wafer's quality affects the quality of the fabricated chips and also of the products in which the chips are applied.

Therefore, in order to control and manage the quality of wafer, different numbers are carved on each produced wafer during the production process of wafer so that the quality of a wafer can be controlled by those numbers, thereby, it is easily to figure out the amount of the wafer and raise the quality of the wafer.

FIG. 1 is a diagram showing the manual wafer carving manner in the prior art. As shown in FIG. 1, an operator holds a carving pen 20a to carve a different specific number 11a on each wafer 10a to let each wafer 10a have a specific number 11a. By the control of this specific number 11a, the management in the production quality and amount of the wafer 10a can be enhanced.

Because the above conventional manual wafer carving manner depends on the strength of each operator, it has the following drawbacks:
(1) Because the applied strength is generally inconsistent, the shape, size, and depth of the carved characters cannot be made uniform. Therefore, the quality of the carved characters cannot be effectively controlled.
(2) Too large applied strengths limit the number of characters that are carved on the wafer, and may even cause breakage of the wafer.
(3) Because of the difference in the sanitary habit, the cleanness degree of the wafer accessed by each operator differs, and the possibility of potential contamination and crack of the wafer during carving may exist.
(4) Because the operator needs to directly access the wafer, the cleanness degree and crack on the wafer and the applied strength cannot be effectively controlled.

In order to conquer the above drawbacks, the applicant has previously proposed a contact laser carving method, in which a specific number is formed on the surface of each wafer by means of laser carving. Besides, it is necessary to finish a center orientation operation and a flat orientation operation of the wafer before laser carving to directly accomplish the orientation of the wafer during the edge-detecting orientation. A flat orienting stopper is arranged in the forward direction of the wafer so that the wafer can directly colloid with the stopper to stop when moving forward toward the orienting stopper, thereby simultaneously completing the center orientation operation and the flat orientation of the wafer.

In the above contact laser carving method, the wafer directly colloids with the orienting stopper to complete the center and flat orientation operations. Because of the hardness of the wafer, there will be scars formed on the orienting stopper to cause the following disadvantages:
(1) Owing to the scars, the deviation of the wafer during the center orientation will happen, resulting in the deviation of the position of the carved characters. Therefore, the laser carving action cannot be precisely carried out on the position of the carved characters.
(2) Owing to the non-uniformity of the scars, crack on the flat corner surface of the wafer may easily occur, not only causing the breakage of the wafer, but also affecting the integrity of the whole wafer.

### SUMMARY OF THE INVENTION

An object of the present invention is to provide a non-contact laser carving process and the equipment, which makes use of the orientation of an orienting module to precisely amend and orient the center of a wafer to the orienting module so that the wafer won't contact or collide with other objects to cause any crack on the flat corner surface or any breakage of wafer. Besides, the present invention makes use of the rotation of the orienting module and an optical sensor of a transmission mechanical module to precisely get the center of the wafer, and also makes use of the compensation of the optical sensor to orient a specific boundary position.

No matter what the external diameter of the wafer is, laser carving can be precisely performed at the specific boundary position in the wafer by the compensation and transmission of the transmission mechanical module cooperated with the laser-carving unit, and a specific number can be carved at the specific boundary position of each wafer. Therefore, the wafer can be efficiently traced and controlled, and the amount of the wafer can be figured out easily to raise the quality of the wafer when the wafer is produced and transported.

To achieve the above object, the present invention provides a non-contact laser carving process, which is used to carve a specific number on each wafer by laser so as to efficiently trace and control wafers and easily figure out the amount of wafers. The process comprises the steps of: using an entry station unit to load and transport a wafer; using an orienting unit to fetch the wafer loaded and delivered by the entry station unit and to amend and orient the center of the wafer; using a transmission unit cooperated with the orienting unit to perform edge-detecting orientation and boundary position compensation of the wafer and to receive the wafer for transmission; using a laser carving unit cooperated with the transmission unit to carve a specific number at a predetermined boundary position of the wafer by laser; and using an exit station unit cooperated with the transmission unit to unload and transport the wafer with the specific number.

To achieve the above object, the present invention also provides a non-contact laser carving equipment, which is used to carve a specific number on each wafer by laser so as to efficiently trace and control wafers and easily figure out the amount of wafers. The equipment comprises an entry station unit and an exit station unit, an orienting unit corresponding to the entry station unit, a transmission unit, and a laser carving unit. The entry station unit and the exit station unit have an entry deliver region and an exit deliver region for entry and exit loading and transport of each wafer, respectively. The orienting unit is used to fetch the wafer loaded by the entry station unit and to amend and orient the center of the wafer. The transmission unit cooperates with the orienting unit to perform edge-detecting orientation, boundary position compensation and transmission of each wafer. The laser carving unit cooperates with the transmission unit to carve a specific number at a predetermined boundary position of a wafer by laser so as to let each wafer have a specific number.

### BRIEF DESCRIPTION OF THE DRAWINGS

The various objects and advantages of the present invention will be more readily understood from the following detailed description when read in conjunction with the appended drawing, in which:

FIG. 1 is a diagram showing the manual wafer carving manner in the prior art;

FIG. 2 is a flowchart of the non-contact laser carving process of the present invention;

FIG. 3 is a diagram of the non-contact laser carving equipment of the present invention;

FIG. 4A is a diagram showing the action of orienting the center of a wafer in the non-contact laser carving process of the present invention;

FIG. 4B is another diagram showing the action of orienting the center of a wafer in the non-contact laser carving process of the present invention;

FIG. 5 is a diagram showing the action of preparing to orient the flat of a wafer in the non-contact laser carving process of the present invention;

FIG. 5A is a diagram showing the action of orienting the flat of a wafer in the non-contact laser carving process of the present invention;

FIG. 5B is another diagram showing the action of orienting the flat of a wafer in the non-contact laser carving process of the present invention;

FIG. 6A is a partly enlarged diagram of FIG. 5A;

FIG. 6B is a partly enlarged diagram of FIG. 5B;

FIG. 7 is a diagram showing the action of performing the boundary position compensation of a wafer in the non-contact laser carving process of the present invention;

FIG. 7A is a partly enlarged diagram of FIG. 7;

FIG. 8 is a diagram showing the action of preparing to transmit a wafer in the non-contact laser carving process of the present invention;

FIG. 9 is a diagram showing the action of transmitting a wafer for laser carving in the non-contact laser carving process of the present invention;

FIG. 10 is a diagram showing the action of preparing to fetch a wafer after the orientation, compensation, and laser carving of the wafer are finished in the non-contact laser carving process of the present invention;

FIG. 11 is a diagram showing the action of fetching a wafer after the orientation, compensation, and laser carving of the wafer are finished in the non-contact laser carving process of the present invention; and

FIG. 12 is a diagram showing the actions of carving a wafer by laser and retrieving a wafer in the non-contact laser carving process of the present invention.

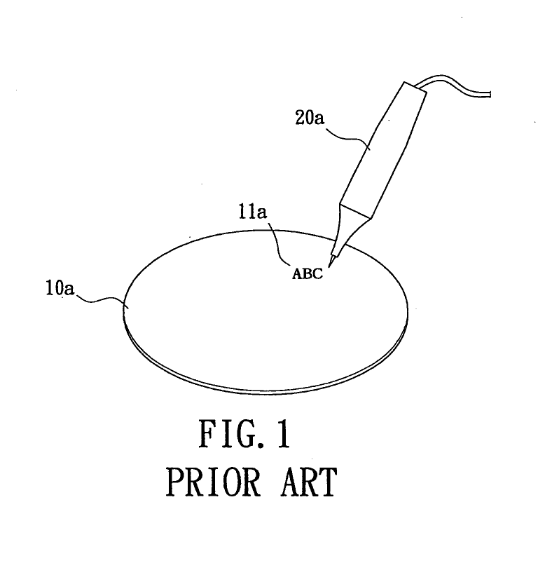

### DETAILED DESCRIPTION OF THE PREFERRED EMBODIMENTS

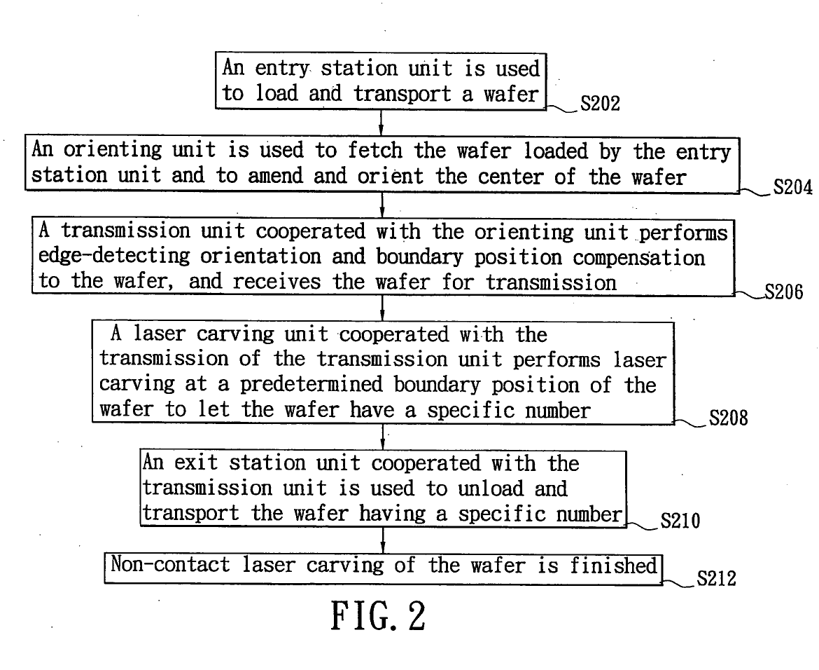

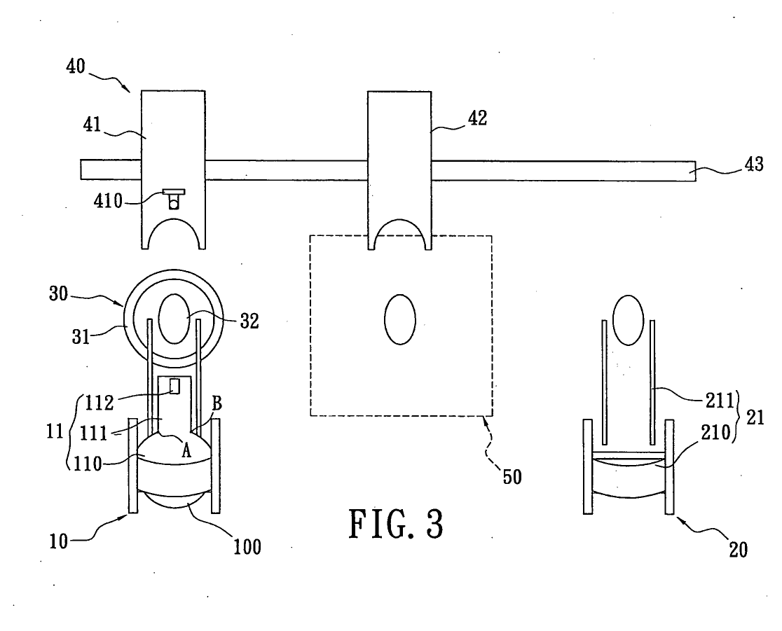

As shown in FIGS. 2 and 3, the present invention provides a non-contact laser carving process and the equipment, which are used to carve a specific number on each wafer 100 by laser so as to efficiently trace and control each wafer 100 and easily figure out the amount of wafer. The non-contact laser carving process comprises the following steps. First, an entry station unit 10 is used to load and transport a wafer 100 (Step S202). An orienting unit 30 is then used to fetch the wafer 100 loaded by the entry station unit 10 and to amend and orient the center of the wafer 100 (Step S204). Next, a transmission unit 40 cooperated with the orienting unit 30 performs edge-detecting orientation and boundary position compensation to the wafer 100, and receives the wafer 100 for transmission (Step S206). Subsequently, a laser carving unit 50 cooperated with the transmission of the transmission unit 40 performs laser carving at a predetermined boundary position of the wafer 100 to let the wafer 100 have a specific number (Step S208). Finally, an exit station unit 20 cooperated with the transmission unit 40 is used to unload and transport the wafer 100 having a specific number (Step S210). Therefore, the non-contact laser carving of the wafer 100 is finished (Step S212).

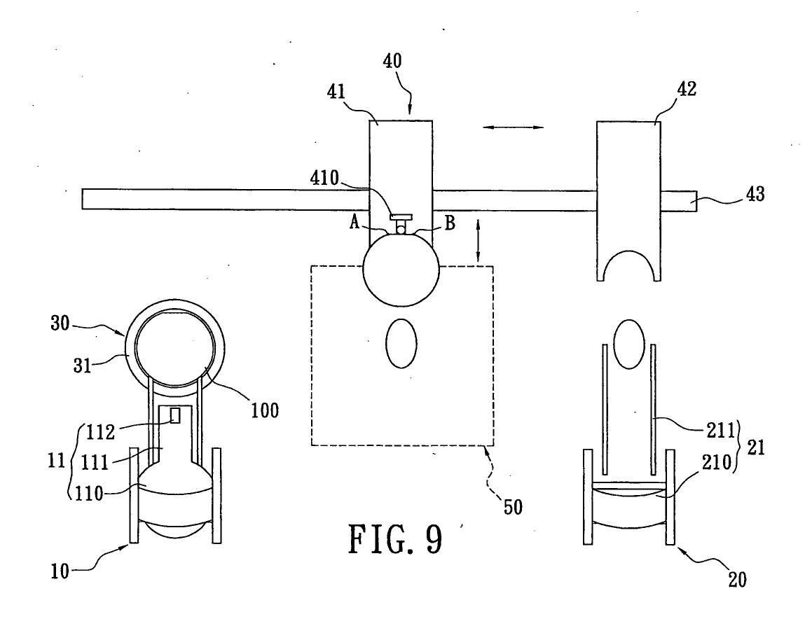

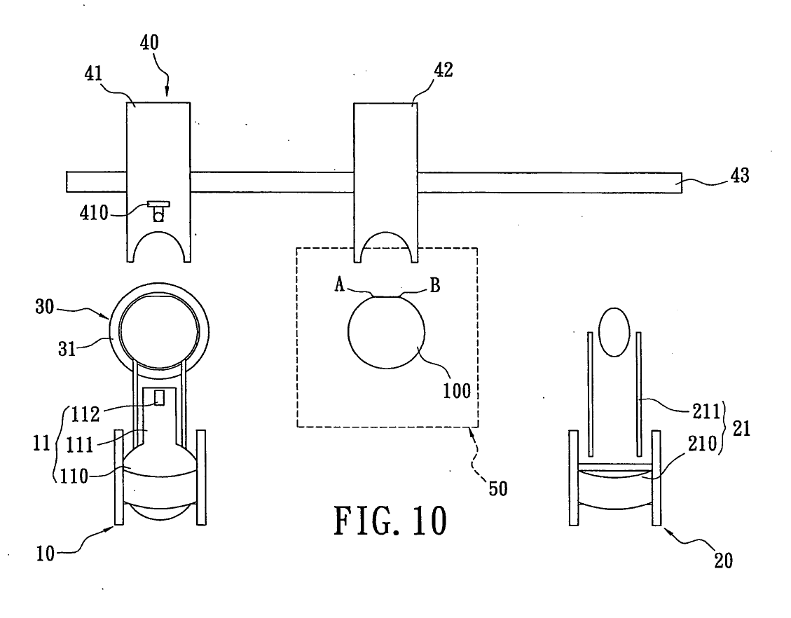

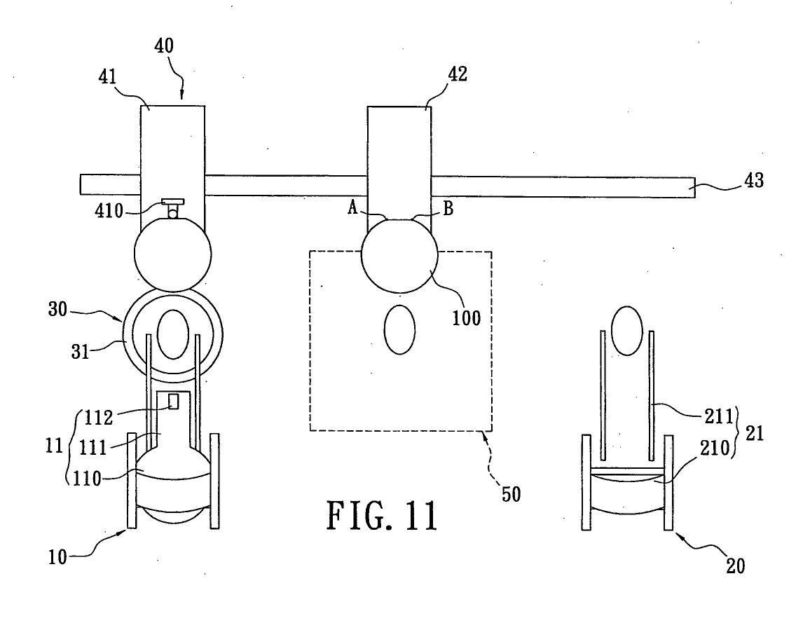

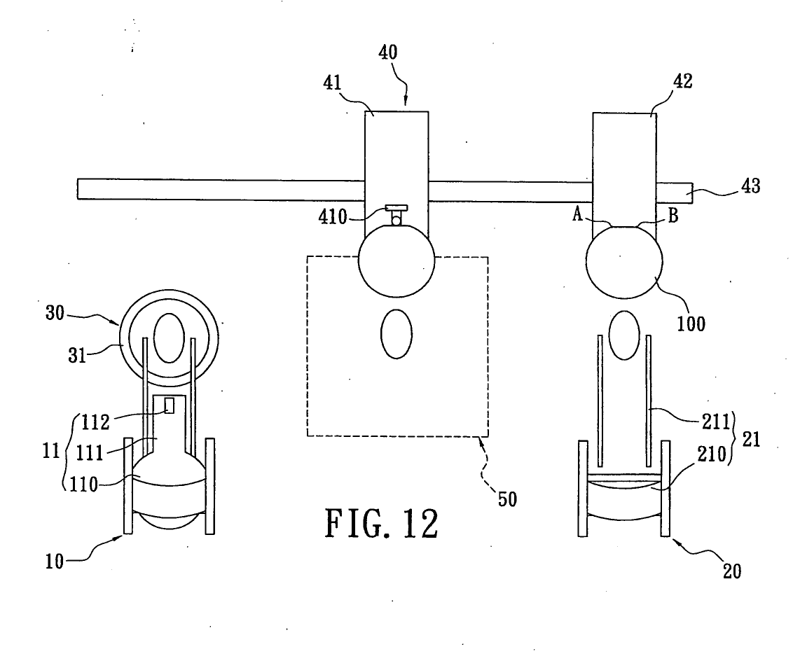

FIGS. 3 to 12 show the non-contact laser carving equipment and actions of the present invention. The present invention makes use of the equipment to realize the above non-contact laser carving steps.

As shown in FIG. 3, the non-contact laser carving equipment comprises an entry station unit 10 and an exit station unit 20, an orienting unit 30 corresponding to the entry station unit 10, a transmission unit 40, and a laser carving unit 50.

In the present invention, the entry station unit 10 includes an entry deliver region 11, and the exit station unit 20 includes an exit deliver region 21. The entry and exit deliver region 11,21 include a loading mechanism 110,210 and a conveyance mechanism 111,211. In the exit deliver region 11, the loading mechanism 110 is used to load a plurality of wafers 100, the conveyance mechanism 111 conveys the wafers 100 to the orienting unit 30. The conveyance mechanism 111 can be a belt conveyance mechanism with a positioning sensor 112 disposed at the distal end thereof. By the friction conveyance of the belt and the sensing of the positioning sensor 112, a wafer 100 can be positioned at a predetermined position when the belt conveyance mechanism conveys the wafer 100 to the orienting unit 30. In the exit deliver region 21, the conveyance mechanism 211 is used to receive and convey the wafer 100 with a specific number transmitted by the transmission unit 40, and the loading mechanism 210 is used to load the plurality of wafers 100 for unloading and transport.

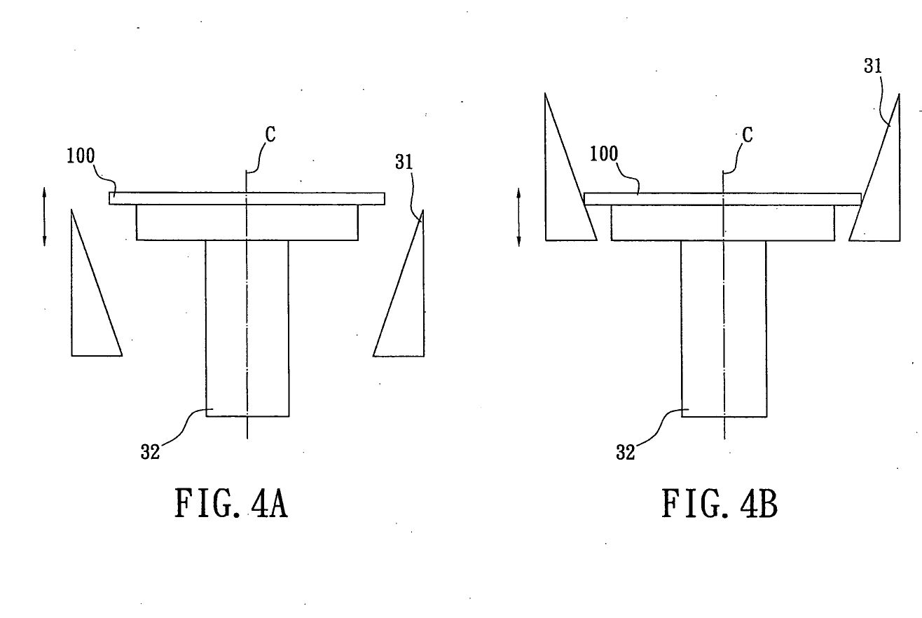

As shown in FIGS. 4A and 4B, the orienting unit 30 is an edge-detecting orienting module, which is used to amend and orient the center C of the wafer 100. The edge-detecting orienting module includes a flat orienting mechanism 31 and an edge-detecting chuck mechanism 32. The wafer 100 is received and the center C of the wafer 100 is amended and oriented by the up motion of the flat orienting mechanism 31, and the center C of the wafer 100 is made identical to the center of the edge-detecting chuck mechanism 32 by the down motion of the flat orienting mechanism 31 cooperated with the edge-detecting chuck mechanism 32. The edge-detecting chuck mechanism 32 sucks the wafer 100 by vacuum to let the center of the edge-detecting chuck mechanism 32 be identical to the center C of the wafer 100.

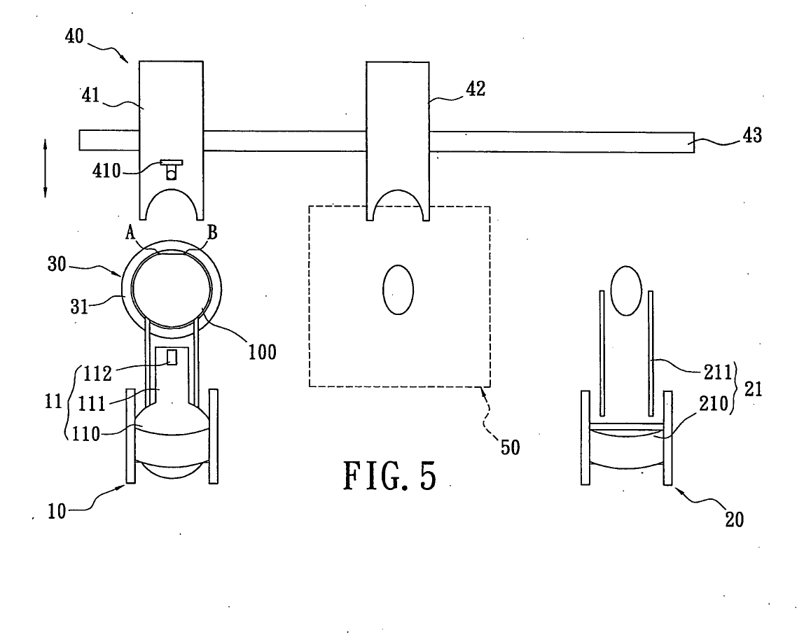

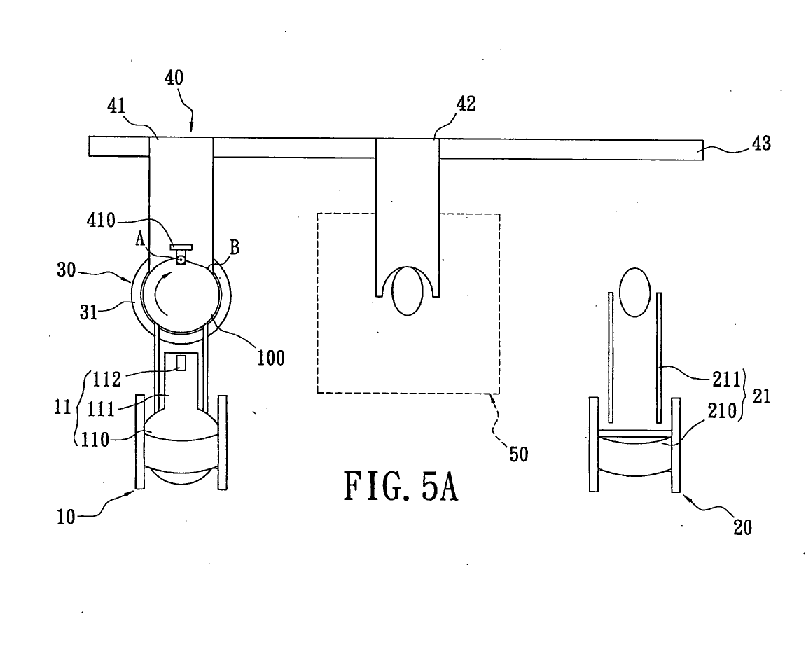

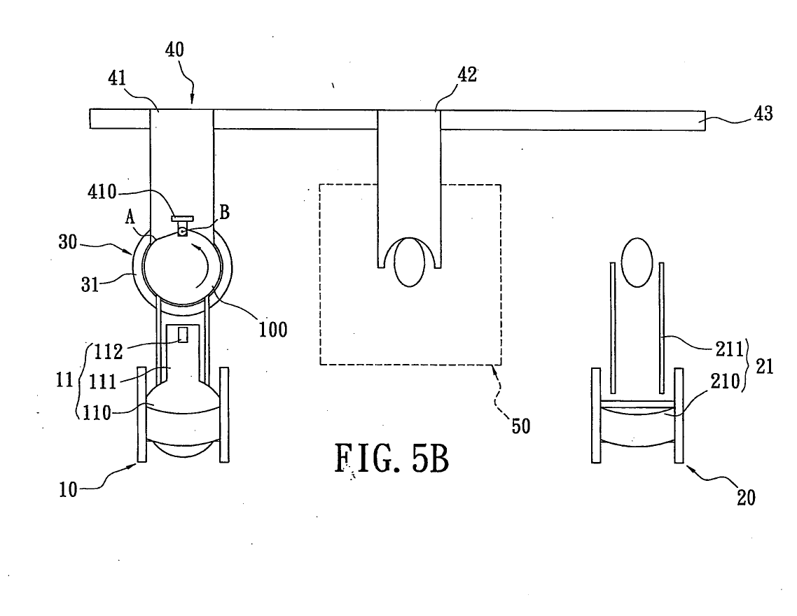

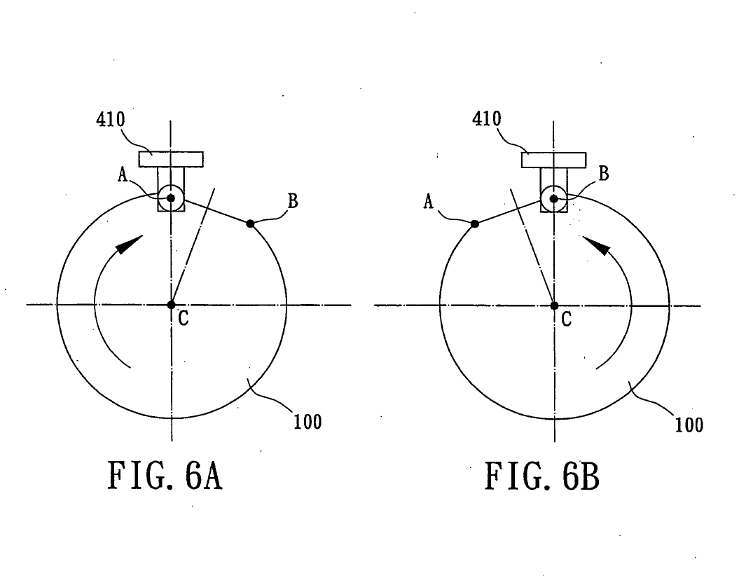

As shown in FIGS. 5 to 6B, the transmission unit 40 is a transmission mechanical module. The transmission mechanism module cooperated with the edge-detecting orienting module to proceed the edge-detecting orientation and boundary position compensation of the wafer 100. The transmission mechanical module also receives the wafer 100 for transmission. The transmission mechanical module includes a first transmission mechanism 41, a second transmission mechanism 42, and a parallel track 43. The first and second transmission mechanisms 41,42 are movably arranged on the parallel track 43 to transport the wafer 100.

The first transmission mechanism 41 includes an optical sensor 410, which is a single-point detection non-contact optical sensor. The optical sensor 41 cooperated with the edge-detecting chuck mechanism 32 to get the center C of the wafer 100, search the flat point, and accomplish the boundary position compensation. By the left and right rotation of the edge-detecting chuck mechanism 32 cooperated with the sensing of the optical sensor 410, two boundary positions A and B of the wafer 100 can be detected. By the detection of the two boundary positions A and B, the first transmission mechanism 41 can perform precise calculation to intercept the center C of the wafer 100.

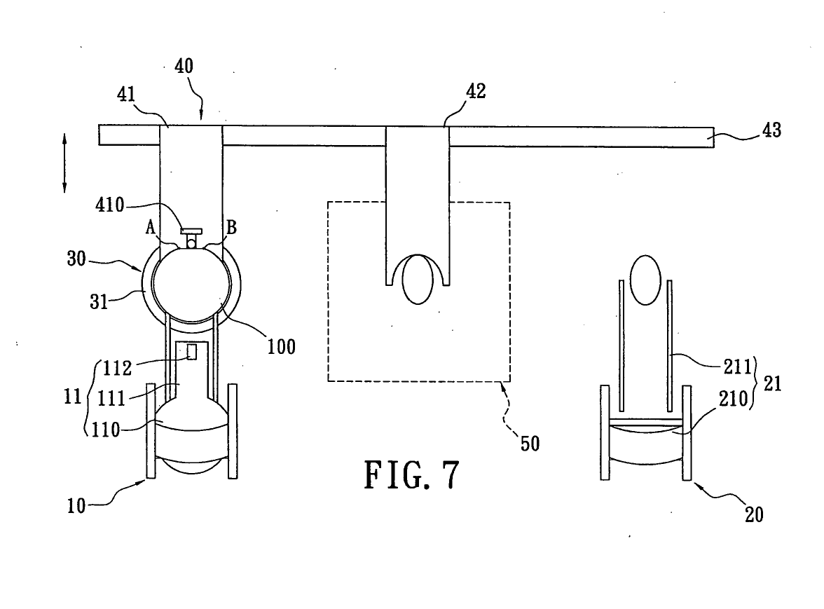

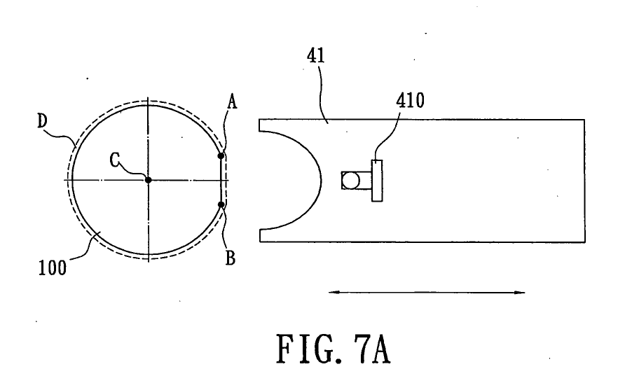

As shown in FIGS. 7 and 7A, the optical sensor 410 can move relative to the two boundary positions A and B of the wafer 100 to carry out the detection of position difference compensation for the boundary position difference D of the wafer 100. The wafer 100 can thus have a fixed boundary distance to form a predetermined boundary position, thereby facilitating laser carving operation of the laser carving unit 50.

In other words, the optical sensor 410 is a flat orienting optical sensor 410, which moves relative to the wafer 100 to perform the detection of position difference compensation for the boundary position difference D of the wafer 100 caused by unequal outer diameter of the wafer 100. The wafer 100 can thus have a fixed boundary distance to form a predetermined boundary position, thereby facilitating laser carving operation of the laser carving unit 50.

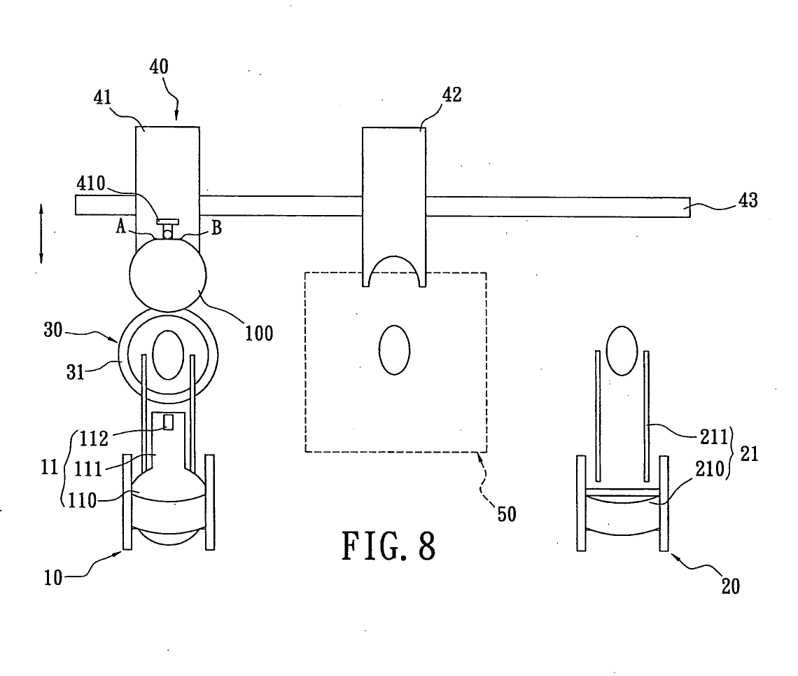

As shown in FIGS. 8 to 12, the first transmission mechanism 41 is a stepping motor arm mechanism, which is used to precisely control the orientation position of the wafer 100. The second transmission mechanism 42 is an air cylinder arm mechanism, which is used to fetch and retrieve the wafer 100 that is carved by the laser carving unit 50. The first and second transmission mechanisms 41,42 move parallel and synchronous to each other to achieve stable parallel transmission. By the transmission of the first and second transmission mechanisms 41,42, the laser carving action and the transport action for exit storage of the wafer 100 can be smoothly carried out after the edge-detecting orientation action and the laser carving action, respectively.

When the transmission mechanical module operates in a first working state, the first transmission mechanism 41 corresponds to the edge-detecting orienting module to load a wafer 100 amended and oriented by the edge-detecting orienting module, and the second transmission mechanism 42 corresponds to the laser carving unit 50 to load a wafer 100 carved by the laser carving unit 50. When the transmission mechanical module operates in a second working state, the first transmission mechanism 41 corresponds to the laser carving unit 50 to let the laser carving unit 50 carve the wafer 100, and the second transmission mechanism 42 corresponds to the exit station unit 20 and unloads the wafer 100 carved by the laser carving unit 50 at the exit station unit 20. The wafer 100 with a specific number can therefore be conveyed and unloaded via the loading mechanism 210 and the conveyance mechanism 211 of the exit deliver region 21.

Besides, in the present invention, the laser selected in the laser carving unit 50 is an air-cooled laser (FAYB, Fiber Amplified Ytterbium), which can fix the focal length of laser light for the optical axis adjustment without the need of periodic adjustment. Moreover, the air-cooled laser can be immediately excited to lase for carving without the need of a long time of excitation when used to carve the wafer 100. Because the laser is an air-cooled laser, no liquid (e.g., water) is required for cooling to accomplish the heat-radiating effect, Furthermore, the laser occupies a smaller space, and is easier to maintain. To sum up, the present invention has the following advantages:
(1) The laser carving process is automated by the design of the equipment to avoid the problems of breakage and contamination of wafer due to manual access of wafer.

(2) By the cooperation of the edge-detecting orienting module and the transmission mechanical module, the center orientation and the boundary orientation and compensation of a wafer are proceeded in a non-contact way. The possibility of crack of the wafer due to collision and contact during the orientation process can be avoided to keep the integrity of the wafer.
(3) In the consideration of no increase in the space of the production line, this non-contact laser carving idea is exploited to achieve a consistent effect in the shape and depth of the carved characters with no limit in the number of the carved characters.
(4) No matter what the size and weight of the wafer, the automated transmission and positioning accuracy of the equipment of the present invention won't be affected.
(5) The operation of the designed equipment is simple and easy so that the operator can conveniently control the equipment to reduce the possibility of manual operation error.
(6) The selected laser (air-cooled laser) has obvious advantages in optical axis adjustment, carving, heat radiation, occupied space, and maintenance. Moreover, the selected laser is convenient to operate, and has a lower cost.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A non-contact laser carving process used to carve a specific number on each wafer by laser so as to efficiently trace and control said wafer and easily figure out the amount of said wafer, said process comprising the steps of:
(a) using an entry station unit to load and transport said wafer;
(b) using an orienting unit to fetch said wafer loaded and delivered by said entry station unit and to amend and orient the center of said wafer;
(c) using a transmission unit cooperated with said orienting unit to perform an edge-detecting orientation and a boundary position compensation of said wafer and to receive said wafer for transmission;
(d) using a laser carving unit cooperated with said transmission unit to carve a specific number at a predetermined boundary position of the wafer by laser; and
(e) using an exit station unit cooperated with said transmission unit to unload and transport said wafer with the specific number.

2. The non-contact laser carving process as claimed in claim 1, wherein said entry station unit includes an entry deliver region, and said exit station unit includes an exit deliver region, both said entry deliver region and said exit deliver region have a loading mechanism and a conveyance mechanism, said loading mechanism is used to load said wafer, and said conveyance mechanism is used to convey said wafer.

3. The non-contact laser carving process as claimed in claim 2, wherein in said step (a), said conveyance mechanism is a belt conveyance mechanism, a positioning sensor is disposed at a distal end of said belt conveyance mechanism, said wafer is positioned by the sensing of said positioning sensor when said belt conveyance mechanism transports said wafer to said orienting unit.

4. The non-contact laser carving process as claimed in claim 1, wherein in said step (b), said orienting unit is an edge-detecting orienting module, and the center of said wafer is amended and oriented to said edge-detecting orienting module by the orientation of said edge-detecting orienting module.

5. The non-contact laser carving process as claimed in claim 4, wherein in said step (c), said transmission unit is a transmission mechanical module, the edge-detecting orientation and boundary position compensation of said wafer are performed by said transmission mechanical module cooperated with said edge-detecting orienting module, and said transmission mechanical module receives said wafer for transmission.

6. The non-contact laser carving process as claimed in claim 1, wherein in said step (b), said orienting unit is an edge-detecting orienting module, said edge-detecting orienting module includes a flat orienting mechanism and an edge-detecting chuck mechanism, said wafer is received and the center of said wafer is amended and oriented by the up motion of said flat orienting mechanism, and the center of said wafer is made identical to the center of said edge-detecting chuck mechanism by the down motion of said flat orienting mechanism cooperated with said edge-detecting chuck mechanism.

7. The non-contact laser carving process as claimed in claim 6, wherein in said step (b), said edge-detecting chuck mechanism sucks said wafer by vacuum to let the center of said edge-detecting chuck mechanism be identical to the center of said wafer.

8. The non-contact laser carving process as claimed in claim 6, wherein in said step (c), said transmission unit is a transmission mechanical module, said transmission mechanism module includes a first transmission mechanism, a second transmission mechanism and a parallel track, said first and second transmission mechanisms are movably arranged on said parallel track to transport a wafer, said first transmission mechanism includes an optical sensor, two boundary positions of said wafer are separately detected by the left and right rotation of said edge-detecting chuck mechanism cooperated with said optical sensor, and said first transmission mechanism precisely calculates and intercepts the center of said wafer by the detection of said two boundary positions.

9. The non-contact laser carving process as claimed in claim 8, wherein in said step (c), said optical sensor moves relative to said wafer to perform the sensing of a position difference compensation to a boundary position difference of said wafer to let said wafer have a fixed boundary distance so as to form said predetermined boundary position, thereby facilitating the laser carving of said laser carving unit.

10. The non-contact laser carving process as claimed in claim 8, wherein in said step (c), said optical sensor is a flat orienting optical sensor, said flat orienting optical sensor moves relative to said wafer to perform the sensing of a position difference compensation to a boundary position difference due to non-uniform size of said wafer to let said wafer have a fixed boundary distance so as to form said predetermined boundary position, thereby facilitating the laser carving of said laser carving unit.

11. The non-contact laser carving process as claimed in claim 8, wherein said first transmission mechanism is a stepping motor arm mechanism, and said second transmission mechanism is an air cylinder arm mechanism.

12. The non-contact laser carving process as claimed in claim 8, wherein said first and second transmission mechanisms move parallel and synchronous to each other.

13. The non-contact laser carving process as claimed in claim 8, wherein said first transmission mechanism corresponds to said edge-detecting orienting module to load said wafer amended and oriented by said edge-detecting orienting module, said second transmission mechanism corresponds to said laser carving unit to load said wafer carved by said laser carving unit when said transmission mechanical module operates in a first working state; and said first transmission mechanism corresponds to said laser carving unit to let said laser carving unit carve said wafer, said second transmission mechanism corresponds to said exit station unit and unloads said wafer carved by said laser carving unit at said exit station unit when said transmission mechanical module operates in a second-working state.

14. A non-contact laser carving equipment used to carve a specific number on each wafer by laser so as to efficiently trace and control said wafer and easily figure out the amount of said wafer, said equipment comprising: an entry station unit and an exit station unit having an entry deliver region and an exit deliver region for entry and exit loading and transport of each wafer, respectively;
an orienting unit corresponding to said entry station unit to fetch said wafer loaded by said entry station unit and to amend and orient the center of said wafer;
a transmission unit cooperated with said orienting unit to perform an edge-detecting orientation, a boundary position compensation and a transmission of each wafer; and
a laser carving unit cooperated with said transmission unit to carve a specific number at a predetermined boundary position of a wafer by laser so as to let each wafer have a specific number.

15. The non-contact laser carving equipment as claimed in claim 14, wherein both said entry deliver region and said exit deliver region have a loading mechanism and a conveyance mechanism, said loading mechanism is used to load said wafer, and said conveyance mechanism is used to convey said wafer.

16. The non-contact laser carving equipment as claimed in claim 15, wherein said conveyance mechanism is a belt conveyance mechanism, a positioning sensor is disposed at a distal end of said belt conveyance mechanism, said wafer is positioned by the sensing of said positioning sensor when said belt conveyance mechanism transports said wafer to said orienting unit.

17. The non-contact laser carving equipment as claimed in claim 14, wherein said orienting unit is an edge-detecting orienting module, and the center of said wafer is amended and oriented to said edge-detecting orienting module by the orientation of said edge-detecting orienting module.

18. The non-contact laser carving equipment as claimed in claim 17, wherein said transmission unit is a transmission mechanical module, the edge-detecting orientation and boundary position compensation of said wafer are performed by said transmission mechanical module cooperated with said edge-detecting orienting module, and said transmission mechanical module receives said wafer for transmission.

19. The non-contact laser carving equipment as claimed in claim 14, wherein said orienting unit is an edge-detecting orienting module, said edge-detecting orienting module includes a flat orienting mechanism and an edge-detecting chuck mechanism, said wafer is received and the center of said wafer is amended and oriented by the up motion of said flat orienting mechanism, and the center of said wafer is made identical to the center of said edge-detecting chuck mechanism by the down motion of said flat orienting mechanism cooperated with said edge-detecting chuck mechanism.

20. The non-contact laser carving equipment as claimed in claim 19, wherein said edge-detecting chuck mechanism sucks said wafer by vacuum to let the center of said edge-detecting chuck mechanism be identical to the center of said wafer.

21. The non-contact laser carving equipment as claimed in claim 19, wherein said transmission unit is a transmission mechanical module, said transmission mechanism module includes a first transmission mechanism, a second transmission mechanism and a parallel track, said first and second transmission mechanisms are movably arranged on said parallel track to transport a wafer, said first transmission mechanism includes an optical sensor, two boundary positions of said wafer are separately detected by the left and right rotation of said edge-detecting chuck mechanism cooperated with said optical sensor, and said first transmission mechanism precisely calculates and intercepts the center of said wafer by the detection of said two boundary positions.

22. The non-contact laser carving equipment as claimed in claim 21, wherein said optical sensor moves relative to said wafer to perform the sensing of a position difference compensation to a boundary position difference of said wafer to let said wafer have a fixed boundary distance so as to form said predetermined boundary position, thereby facilitating the laser carving of said laser carving unit.

23. The non-contact laser carving equipment as claimed in claim 21, wherein said optical sensor is a flat orienting optical sensor, said flat orienting optical sensor moves relative to said wafer to perform the sensing of a position difference compensation to a boundary position difference due to non-uniform size of said wafer to let said wafer have a fixed boundary distance so as to form said predetermined boundary position, thereby facilitating the laser carving of said laser carving unit.

24. The non-contact laser carving equipment as claimed in claim 21, wherein said first transmission mechanism is a stepping motor arm mechanism, and said second transmission mechanism is an air cylinder arm mechanism.

25. The non-contact laser carving equipment as claimed in claim 21, wherein said first and second transmission mechanisms move parallel and synchronous to each other.

26. The non-contact laser carving equipment as claimed in claim 21, wherein said first transmission mechanism corresponds to said edge-detecting orienting module to load said wafer amended and oriented by said edge-detecting orienting module, said second transmission mechanism corresponds to said laser carving unit to load said wafer carved by said laser carving unit when said transmission mechanical module operates in a first working state; and said first transmission mechanism corresponds to said laser carving unit to let said laser carving unit carve said wafer, said second transmission mechanism corresponds to said exit station unit and unloads said wafer carved by said laser carving unit at said exit station unit when said transmission mechanical module operates in a second working state.
